(19) United States
(12) Patent Application Publication
(10) Pub. No.: US 2025/0081872 A1
(43) Pub. Date: Mar. 13, 2025

(54) PERFORATOR FOR LAWN AERATOR AND LAWN AERATOR HAVING SAME

(71) Applicant: Suzhou Firefly Information Technology Co., Ltd., Suzhou (CN)

(72) Inventor: Muzhi HUANG, Suzhou (CN)

(73) Assignee: Suzhou Firefly Information Technology Co., Ltd., Suzhou (CN)

(21) Appl. No.: 18/604,316

(22) Filed: Mar. 13, 2024

(30) Foreign Application Priority Data
Sep. 8, 2023 (CN) 202322447157.6

(51) Int. Cl. A01B 45/02

(52) U.S. Cl. CPC A01B 45/02

(57) ABSTRACT

Disclosed are a perforator and a lawn aerator. The perforator includes a main portion and a plurality of perforating portions. The main portion is in a disk shape, and the perforating portions are integrally formed with the main portion. The perforating portions extend radially outward from an outer periphery of the main portion, and are arranged at intervals in a circumferential direction of the main portion. Each perforating portion forms a cutting portion at a distal end thereof. Between cutting portions of any two adjacent perforating portions, an edge of the perforator is turned over towards one side of the perforator to form a turned-over portion. According to this configuration, a greater bending strength can be obtained. In addition, the connecting portion of the perforating portion and the main portion can be strengthened. Therefore, the manufacturing processes are reduced, and so the manufacturing cost and manufacturing difficulty.

### CROSS-REFERENCE TO RELATED APPLICATIONS

This application claims priority to Chinese Patent Application No. 202322447157.6, filed on Sep. 8, 2023, which is hereby incorporated by reference in its entirety.

### TECHNICAL FIELD

The present disclosure relates to a field of grassland care, in particular to a perforator for a lawn aerator and a lawn aerator having the perforator.

### BACKGROUND

After years of cultivation, lawn soil is prone to harden, and plants are susceptible to diseases and weak in growth. To solve this problem, lawn aerators are usually used to break hardened soil and aerate the soil. However, for land which has extremely hard soil caking and has not been cared for many years, a perforating portion of a lawn aerator used is longer than that of a common lawn aerator. Because the length of the perforating portion is too long, stress provided at a near end of the perforating portion is too large in the process of aeration, which causes the perforating portion to be deformed and reduces the soil aerating effect. If a perforator of the lawn aerator is integrally formed with multiple perforating portions, the perforating portions is prone to break in the process of aeration. Therefore, several independent perforating portions are usually mounted on the lawn aerator, so that the perforating portions can be replaced when they are damaged. However, the way of mounting several independent perforating portions on the lawn aerator increases assembly difficulty. Meanwhile, the problem that the perforating portions are prone to deform due to excessive stress has not been well solved.

### SUMMARY

The present disclosure provides a perforator for a lawn aerator and a lawn aerator having the perforator, so as to solve the problem that perforating portions of a traditional perforator is prone to break and difficult to assemble. The present disclosure intends to improve the overall structural strength of an integrally formed perforator.

In a first aspect, the present disclosure provides a perforator for lawn aerator. The perforator includes a main portion and a plurality of perforating portions. The main portion is in a disk shape. The perforating portions are integrally formed with the main portion, extend radially outward from the outer periphery of the main portion, and are arranged at intervals in a circumferential direction of the main portion. Each perforating portion forms a cutting portion at a distal end thereof. Between cutting portions of any two adjacent perforating portions, an edge of the perforator is turned over towards one side of the perforator to form a turned-over portion.

When the perforator rotates in the soil, the stress generated at the connecting portion of the perforating portion and the main portion is large. If the structure of the perforator is flat, when the perforating portion is subjected to a force from an axial direction of the perforator, a strength against deformation is weak, which leads to tearing at the connecting portion of the perforating portion and the main portion due to excessive stress. In order to enhance the strength of the perforating portion in the axial direction of the perforator and avoid tearing at the connecting portion of the perforating portion and the main portion, in the present disclosure, by turning over the edge between the cutting portions of any two adjacent perforating portions, stress at the connecting portion of the perforating portion and the main portion can be dispersed, and the integrally formed perforating portion can have higher strength at the connecting portion of the perforating portion and the main portion, thus reducing the possibility of tearing. In addition, by turning over the edge of the perforator towards one side of the perforator to form a turned-over portion, the integrally formed perforator is not easily bent when rotating in the soil, and a greater bending strength is realized. In addition, the integrally formed perforator simplifies the assembling process. In addition, via one bending process, the connecting portion of the perforating portion and the main portion can be strengthened, while a space for storing soil can be formed at one side of the perforator. With the space, the soil can be taken out of a hole in the ground and the size of the hole can be enlarged. Therefore, the manufacturing process is reduced, and so the manufacturing cost and manufacturing difficulty.

In an exemplary embodiment, the turned-over portion includes two first turned-over sections and a second turned-over section. The two first turned-over sections are respectively formed at two adjacent sides of the two adjacent perforating portions. The second turned-over section is formed at the periphery of the main portion and located between the two first turned-over sections. Each first turned-over section has a turned-over degree, and the turned-over degree gradually increases in a direction away from the main portion; and/or each first turned-over section has a turned-over width, the turned-over width gradually increases in the direction away from the main portion.

The gradually increasing turned-over angle and/or the gradually widening turned-over width make the ends of the two first turn-over sections away from the main portion tend to contact, so that the distal end of the perforating portion is convergent, which is convenient for the perforating portion to take the soil out of the aeration hole after perforating the soil, and makes the aerating effect in the hole more obvious.

In an exemplary embodiment, the perforator is provided with a plurality of reinforcement portions, and the plurality of reinforcement portions extend radially outward from the main portion into the perforating portions respectively. The strength of the perforator can be further improved by adding a reinforcement portion onto the perforator. The reinforcement portion is at least partially arranged on the perforating portion so as to disperse more forces acting on the perforating portion. In order to avoid tearing caused by excessive shear stress at the connecting portion of the main portion and the perforating portion, in the present disclosure, the reinforcement portion extend radially outward from the main portion into the perforating portion, which can absorb the excessive shear stress generated at the connecting portion to further achieve a greater bending strength.

In an exemplary embodiment, each reinforcement portion is configured as a convex portion formed by stamping the perforator to one side of the perforator. As we all know, in a case that the surface roughness is the same, the larger the contact area, the greater the friction. Because one side of the perforator has a stamped reinforcement portion, the other side of the perforator has a corresponding depression due to the reinforcement portion, which increases the thickness of the perforator to resist stress and strengthens the bending strength. When the perforator is partially inserted into the ground, the friction, on the concave side of the perforator, affecting the advancing of the side along the moving direction and coming from the ground, is reduced. In addition, the friction is also reduced when the perforator goes into and out of the soil, thus improving the speed of perforating the soil. Therefore, it is more labor-saving to perforate.

In a second aspect, the present disclosure also provides a lawn aerator including the perforator according to the first aspect.

### BRIEF DESCRIPTION OF THE DRAWINGS

In order to explain the technical scheme of the embodiments of the present disclosure more clearly, the drawings needed in the embodiments will be briefly introduced below.

It should be understood that the following drawings illustrate only certain embodiments of the present disclosure and therefore should not be considered as limiting the scope.

It should be understood that the same or similar reference numerals are used in the drawings to indicate the same or similar elements (structures or components).

It should be understood that the drawings are only schematic, and the dimensions and proportions of elements (structures or components) in the drawings are not necessarily accurate.

FIG. 1 is a schematic structural view of a perforator according to an embodiment of the present disclosure.

FIG. 2 is a schematic sectional view taken along line A-A in FIG. 1.

FIG. 3 is a schematic structural view of a turned-over portion of the perforator in FIG. 1.

### DETAILED DESCRIPTION OF THE EMBODIMENTS

The following will provide relative clear descriptions of the technical solutions in the embodiments of the present disclosure, in conjunction with the accompanying drawings. It should be understood that the described embodiments are only a part of the embodiments of the present disclosure, not all of them.

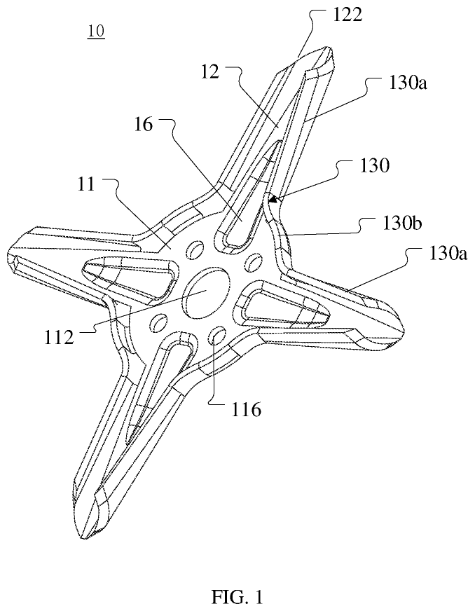

As shown in FIG. 1, the perforator 10 provided by the present disclosure is suitable for aerating in extremely hard soil and breaking the soil caking. Therefore, its portions inserted into the soil is relatively long. In one embodiment according to the present disclosure, the perforator 10 includes a main portion 11 and a plurality of perforating portions 12. The main portion 11 and the plurality of perforating portions 12 are integrally formed. The main portion 11 is in a disk shape, and has a central hole 112. The central hole 112 is configured for a sleeve to pass through. The sleeve may be used to drive the perforator 10 to rotate. The central hole 112 penetrates the main portion 11 along an axis, so that rotation, of the sleeve 20, around the axis drives the perforator 10 to rotate around the axis. The perforating portions 12 extend radially from an outer periphery of the main portion 11, and are arranged along a circumferential direction of the main portion 11. The plurality of perforating portions 12 may be arranged adjacently or at intervals. A cutting portion 122 is formed at a distal end of each perforating portion 12. The cutting portion 122 has a cutting edge, the cutting edge is used for helping the perforating portion 12 to insert into the soil more conveniently, and the cutting portion 122 may be in an arc-shaped or a sharping shape.

Between two cutting portions 122 of any two adjacent perforating portions 12, an edge of the perforator 10 is turned over towards one side of the perforator 10 to form a turned-over portion 130, for example, by stamping.

In order to enhance the strength of the perforating portion 12 in the axial direction of the perforator 10 and avoid tearing at the connecting portion of the perforating portion 12 and the main portion 11, in the present disclosure, by turning over the edge between the cutting portions of any two adjacent perforating portion 12, stress at the connecting portion of the perforating portion 12 and the main portion 11 can be dispersed, and the integrally formed perforating portion 12 can have higher strength at the connecting portion of the perforating portion 12 and the main portion 11, thus reducing the possibility of tearing. In addition, by turning over the edge of the perforator 10 towards one side of the perforator 10 to form a turned-over portion, the integrally formed perforator 10 is not easily bent when rotating in the soil, and a greater bending strength is realized. In addition, the integrally formed perforator 10 simplifies the assembling process. In addition, via one bending process, the connecting portion of the perforating portion 12 and the main portion 11 can be strengthened, while a space for storing soil can be formed at one side of the perforator 10. With the space, the soil can be taken out of a hole in the ground and the size of the hole can be enlarged. Therefore, the manufacturing process is reduced, and so the manufacturing cost and manufacturing difficulty.

The main portion 11 is provided with a plurality of mounting holes 116 for matching with a matched mounting plate, which is around and fixed to the periphery of the sleeve 20, and the perforator 10 is bolted to the mounting plate through the mounting holes 116 on the main portion 11, so that the perforator 10 and the sleeve 20 can be reliably fixed. The quantity of the mounting holes 116 may be at least two.

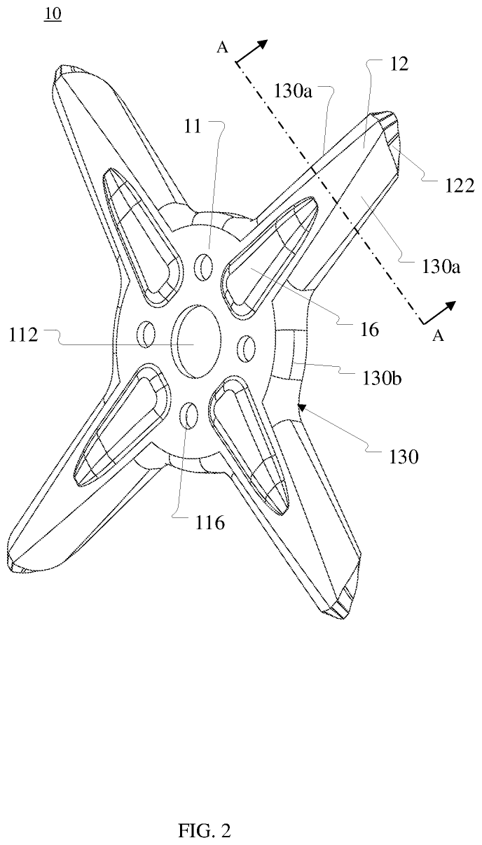

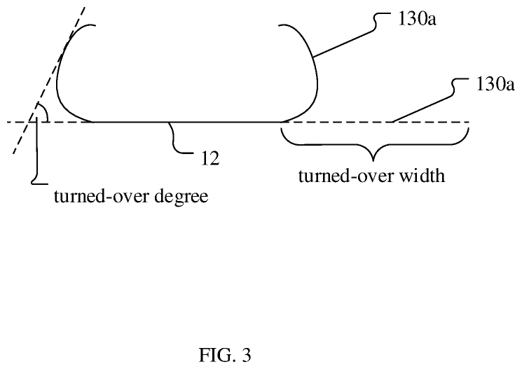

In an embodiment according to the present disclosure, as shown in FIGS. 2 and 3, the turned-over portion 130 includes two first turned-over sections 130a and a second turned-over section 130b. The two first turned-over sections 130a are respectively formed at the two adjacent sides of the two adjacent perforating portions. The second turned-over section 130b is formed at the periphery of the main portion 10 and located between the two first turned-over sections 130a. The first turned-over section 130a and the second turned-over section 130b turn over towards the same side. Each first turned-over section 130a has a turned-over degree. In this embodiment, the turned-over degree can be interpreted as 0° when the first turned-over section 130a is not turned over, and 180° when the surface of the first turned-over section 130a is turned to be attached to the unturned portion of the perforating portion 12. In the radial direction of the main portion 11, each first turned-over section 130a has a turned-over degree, and the turned-over degree gradually increases in a direction away from the main portion 11, so that the distance between the two first turned-over sections 130a of each perforating portion 12 reduces in the direction away from the main portion 11. In addition, the cooperation of the first turned-over section 130a and the second turned-over section 130b can take the soil in the aeration hole out of the aeration hole, thus improving the aerating effect. In the radial direction of the main portion 11, the first turned-over section 130a has a turned-over width, the turned-over width gradually increases in a direction away from the main portion 11, so that the distance between two first turned-over sections 130a of each perforating portion 12 reduces in the direction away from the main portion 11. The turned-over width is the width, of the turned-over portion of the perforating portion 12, in the direction perpendicular to the perforating portion 12. In this embodiment, the turned-over sections are arc-shaped. The turned-over width gradually widened in the direction away from the main portion 11 meets the bending strength of the perforating portion 12, while the distance between the two first turned-over sections 130a of the perforating portion 12 gradually decreases, so that the partially hollow perforating portion 12 is formed.

The turned-over width refers to the width of the first turned-over section 130a being horizontally unturned-over, such as the first turned-over section 130a being horizontally unturned-over as indicated by the dotted line in FIG. 3.

In an exemplary embodiment, the perforator 10 is provided with a plurality of reinforcement portions 16, which extend radially outward from the main portion 11 into the plurality of perforating portions 12 respectively. That is, each reinforcement portion 16 is partially located at the connecting portion of the main portion 11 and the perforating portion 12, or in other words, each reinforcement portion 16 extends through the connecting portion of the main portion 11 and the perforating portion 12, which can absorb the excessive shear stress generated at the connecting portion to further achieve a greater bending strength.

In an embodiment, each reinforcement portion 16 is configured as a convex portion formed by stamping the perforator to one side of the perforator. The reinforcement portion 16 can be stamped to either side. As we all know, in a case that the surface roughness is the same, the larger the contact area, the greater the friction. Because one side of the perforator 10 has a reinforcement portion 16, the other side of the perforator 10 has a corresponding depression due to the reinforcement portion 16. When the perforator 10 is partially inserted into the ground, the friction, on the concave side of the perforator 10, affecting the advancing of the one side along the moving direction and coming from the ground, is reduced. In addition, the friction is also reduced when the perforator 10 goes into and out of the soil, thus improving the speed of perforating the soil. Therefore, it is more labor-saving to perforate.

In addition, the embodiments of the present disclosure also provide a lawn aerator, which may include the perforator 10 provided by the above embodiments of the present disclosure.

It should be understood that the term “including” and its variations used in this disclosure are open-ended including, that is, “including but not limited to”. The term “one embodiment” means “at least one embodiment” and the term “another embodiment” means “at least one further embodiment”.

It should be noted that the specific technical features (elements) described in the above specific embodiments can be combined in any suitable way without contradiction, and in order to avoid unnecessary repetition, various possible combination ways are not explained in this disclosure.

The above are only the specific embodiments of this disclosure, but the protection scope of this disclosure is not limited to them. Any person familiar with this technical field can think of changes or substitutions within the technical scope disclosed in this disclosure, which should be included in the protection scope of this disclosure. Therefore, the scope of protection of this disclosure should be based on the scope of protection of the claims.

What is claimed is:

1. A perforator for a lawn aerator, comprising:
a main portion, in a disk shape; and
a plurality of perforating portions, integrally formed with the main portion, extending radially outward from an outer periphery of the main portion, and arranged at intervals in a circumferential direction of the main portion, each perforating portion forming a cutting portion at a distal end thereof,
wherein between cutting portions of any two adjacent perforating portions, an edge of the perforator is turned over towards one side of the perforator to form a turned-over portion.

2. The perforator according to claim 1, wherein the turned-over portion comprises:
two first turned-over sections, respectively formed at two adjacent sides of the two adjacent perforating portions; and
a second turned-over section, formed at the periphery of the main portion, and located between the two first turned-over sections, wherein each first turned-over section has a turned-over degree, and the turned-over degree gradually increases in a direction away from the main portion.

3. The perforator according to claim 1, wherein the turned-over portion comprises:
two first turned-over sections, respectively formed at two adjacent sides of the two adjacent perforating portions; and
a second turned-over section, formed at the periphery of the main portion, and located between the two first turned-over sections, wherein each first turned-over section has a turned-over width, and the turned-over width gradually increases in a direction away from the main portion.

4. The perforator according to claim 1, wherein the turned-over portion comprises:
two first turned-over sections, respectively formed at two adjacent sides of the two adjacent perforating portions; and
a second turned-over section, formed at the periphery of the main portion, and located between the two first turned-over sections, wherein each first turned-over section has a turned-over degree, the turned-over degree gradually increases in a direction away from the main portion, each first turned-over section has a turned-over width, and the turned-over width gradually increases in the direction away from the main portion.

5. The perforator according to claim 1, wherein the perforator is provided with a plurality of reinforcement portions which extend radially outward from the main portion into the plurality of perforating portions respectively.

6. The perforator according to claim 5, wherein each reinforcement portion is configured as a convex portion formed by stamping the perforator to one side of the perforator.

7. A lawn aerator comprising the perforator according to claim 1.
